(19) United States
(12) Patent Application Publication
(10) Pub. No.: US 2025/0317833 A1
(43) Pub. Date: Oct. 9, 2025

(54) METHOD FOR CONTROLLING SENSING FOR TARGET SENSING AREA AND COMMUNICATION SYSTEM PROVIDING THE SAME

(71) Applicant: Electronics and Telecommunications Research Institute, Daejeon (KR)

(72) Inventor: Soohwan LEE, Daejeon (KR)

(73) Assignee: Electronics and Telecommunications Research Institute, Daejeon (KR)

(21) Appl. No.: 19/176,460

(22) Filed: Apr. 11, 2025

(30) Foreign Application Priority Data
Apr. 11, 2024 (KR) 10-2024-0048827
Apr. 10, 2025 (KR) 10-2025-0047084

(51) Int. Cl. H04W 48/08; H04W 48/16

(52) U.S. Cl. CPC H04W 48/08; H04W 48/16

(57) ABSTRACT

A method of controlling sensing on a target sensing area may include: transmitting, by a sensing client, a sensing request including sensing rule information to be applied to the target sensing area to a core network; converting, by the core network, the sensing rule information into an information element for at least one second network function within the core network using at least one first network function; determining, by the core network, a sensing entity to perform a sensing operation corresponding to the sensing request based on the information element using the at least one second network function; and requesting, by the core network, a sensing operation of the sensing entity, wherein the sensing rule information includes sensing rule information specialized for the target sensing area.

### CROSS-REFERENCE TO RELATED APPLICATIONS

This application claims priority to Korean Patent Applications No. 10-2024-0048827, filed on Apr. 11, 2024, and No. 10-2025-0047084, filed on Apr. 10, 2025, with the Korean Intellectual Property Office (KIPO), the entire contents of which are hereby incorporated by reference.

### BACKGROUND

### 1. Technical Field

The present disclosure pertains to the field of communication technology, and more particularly, to a technique for sensing a target and providing sensing information using a communication network.

### 2. Related Art

The content described in this section is provided solely as background information for exemplary embodiments of the present disclosure and does not constitute prior art.

In a wireless communication network, electronic devices such as a base station (BS) and user equipment (UE) wirelessly communicate with each other to transmit or receive data between them. Sensing is a process of acquiring information on surroundings of a device. Sensing may also be used to detect information on an object, such as its location, speed, distance, direction, shape, or texture. This information may be used to improve communication within the network, and also for other application-specific purposes.

Sensing in the communication network has typically been limited to active sensing techniques involving devices that receive and process radio frequency (RF) sensing reference signals. Other sensing techniques, such as passive sensing (e.g. radar) and non-RF sensing (e.g. video imaging and other sensors), may address some limitations of active sensing, but these alternative techniques are typically implemented as standalone systems separate from the communication network.

The 5G communication system has been designed with a focus on communication functions, and sensing techniques are performed separately in independent systems. Sensing techniques that are independent of the communication system result in inefficient use of resources and act as major factors in degrading the reliability and quality of integrated sensing data. Therefore, improvements to address these issues are required.

### SUMMARY

The present disclosure has been devised to address the above-described issues of the prior arts, and an objective of the present disclosure is to propose network functions and procedures for implementing sensing based on wireless signals.

The present disclosure proposes a method of performing sensing by utilizing user equipments (UEs) within a specific area to improve the accuracy of sensing, as well as a system architecture for controlling and managing the same.

The present disclosure proposes a procedure for initiating sensing on a specific target area in a mobile communication system, information elements required to initiate the sensing, a method for controlling the sensing on the specific target area in the mobile communication system, and a network system architecture for supporting the same.

According to a first exemplary embodiment of the present disclosure, a method of controlling sensing on a target sensing area may comprise: transmitting, by a sensing client, a sensing request including sensing rule information to be applied to the target sensing area to a core network; converting, by the core network, the sensing rule information into an information element for at least one second network function within the core network using at least one first network function; determining, by the core network, a sensing entity to perform a sensing operation corresponding to the sensing request based on the information element using the at least one second network function; and requesting, by the core network, a sensing operation of the sensing entity, wherein the sensing rule information includes sensing rule information specialized for the target sensing area.

The sensing rule information may include identification information of the target sensing area and identification information of a sensing profile specialized for the target sensing area.

The sensing rule information may include a designated sensing time, sensing measurement time intervals, a sensing resolution, a preferred sensing access technique, or a preferred sensing mode.

The sensing rule information may include a target sensing object, sensing objectives, a set of sensing events, a list of candidate user equipments (UEs) for sensing, a group identifier (ID), or an application ID.

The determining of the sensing entity may comprise: acquiring information on an Access and Mobility Management (AM) network function related to the sensing entity based on the information element.

The determining of the sensing entity may comprise: selecting the sensing entity from a list of candidate UEs located within the target sensing area.

In the determining of the sensing entity, the sensing entity may be determined based on the information element by using a sensing policy or UE configuration information obtained from a Unified Data Repository (UDR).

The determining of the sensing entity may comprise: determining whether to store, update, or delete the information element corresponding to the sensing rule information in a UDR.

The transmitting of the sensing request may comprise: determining, by the sensing client, whether to transmit the sensing request for the target sensing area to the core network based on a sensing trigger request received from a UE.

The requesting of the sensing operation may comprise: transmitting, to the sensing entity, information of the target sensing area; and transmitting, to the sensing entity, sensing interval, resolution, or reporting period as configuration detail information for the sensing request.

According to a second exemplary embodiment of the present disclosure, a communication network system may comprise: at least one entity, and the at least one entity may comprise: a computer-readable memory storing at least one instruction; and a processor executing the at least one instruction, wherein the at least one entity may be configured, by executing the at least one instruction, to: receive, from a sensing client, a sensing request including sensing rule information to be applied to a target sensing area; convert the sensing rule information into an information element for at least one second network function using at least one first network function; determine a sensing entity to perform a sensing operation corresponding to the sensing request based on the information element using the at least one second network function; and request a sensing operation of the sensing entity, wherein the sensing rule information includes sensing rule information specialized for the target sensing area.

The sensing rule information may include identification information of the target sensing area and identification information of a sensing profile specialized for the target sensing area.

The sensing rule information may include a designated sensing time, sensing measurement time intervals, a sensing resolution, a preferred sensing access technique, or a preferred sensing mode.

The sensing rule information may include a target sensing object, sensing objectives, a set of sensing events, a list of candidate user equipments (UEs) for sensing, a group identifier (ID), or an application ID.

The at least one entity may be further configured to: acquire information on an Access and Mobility Management (AMF) network function related to the sensing entity based on the information element to determine the sensing entity.

The at least one entity may be further configured to: select the sensing entity from a list of candidate UEs located within the target sensing area to determine the sensing entity.

For the requesting of the sensing operation, the at least one entity may be further configured to: transmit, to the sensing entity, information of the target sensing area; and transmit, to the sensing entity, sensing interval, resolution, or reporting period as configuration detail information for the sensing request.

According to a third exemplary embodiment of the present disclosure, a method of managing a user equipment (UE) for sensing on a target sensing area may comprise: converting, by a core network, sensing rule information to be applied to a target sensing area, which is included in a sensing request received from a sensing client, into an information element for at least one second network function within the core network using at least one first network function; storing and managing, by the core network, the information element in a Unified Data Repository (UDR) using the at least one second network function; determining, by the core network, a UE as a sensing entity candidate for the sensing request based on a sensing entity registration request received from the UE using the at least one second network function; and transmitting, by the core network, a sensing request message requesting a sensing operation for the sensing request to the user equipment (UE).

The sensing rule information may include identification information of the target sensing area and identification information of a sensing profile specialized for the target sensing area, and may further include a designated sensing time, sensing measurement time intervals, a sensing resolution, a preferred sensing access technique, a preferred sensing mode, a target sensing object, sensing objectives, or a set of sensing events.

The sensing entity registration request may include information on a change in an Access and Mobility Management (AMF) network function of the UE due to a change in mobility of the UE.

According to exemplary embodiments of the present disclosure, network functions and procedures for implementing sensing techniques based on wireless signals can be implemented.

According to exemplary embodiments of the present disclosure, a method of performing sensing by utilizing UE(s) within a specific area and a system architecture for controlling and managing the same are proposed, thereby enabling improvement in sensing accuracy.

According to exemplary embodiments of the present disclosure, a procedure for initiating sensing on a specific target area in a mobile communication system, information elements required to initiate the sensing, a method for controlling sensing on the specific target area in the mobile communication system, and a network system architecture for supporting the same can be implemented.

According to exemplary embodiments of the present disclosure, devices or entities capable of performing sensing within a specific target area can be recognized and/or utilized, thereby can be enabled to join in sensing within the specific target area.

According to exemplary embodiments of the present disclosure, group sensing based on cooperation among sensing devices or sensing entities within a specific target area can be provided, and group sensing results measured at a plurality of sensing device and entities within the specific target area can be gathered and be processed, thereby enabling improvement in sensing accuracy within the specific target area.

### BRIEF DESCRIPTION OF DRAWINGS

FIG. 1 is a diagram conceptually illustrating a sensing service based on a wireless signal and a core network supporting the service according to an exemplary embodiment of the present disclosure.

FIG. 2 is a diagram conceptually illustrating an operation of the surrounding infrastructure around the core network shown in FIG. 1.

FIG. 3 is a diagram conceptually illustrating a method for controlling sensing on a target sensing area according to an exemplary embodiment of the present disclosure.

FIGS. 4 to 7 are sequence diagrams illustrating processes for a method of controlling sensing on a target sensing area according to an exemplary embodiment of the present disclosure.

FIGS. 8 and 9 are sequence diagrams illustrating processes for a method of managing a UE for sensing a target sensing area according to another exemplary embodiment of the present disclosure.

FIG. 10 is a conceptual diagram illustrating an example of a generalized computing system in which an entity within the core network 100 capable of performing at least part of the processes of FIGS. 1 to 9, a sensing entity participating in a sensing process by interacting with the core network 100, or a part thereof is implemented.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Meanwhile, even if a technology is known prior to the filing date of the present disclosure, it may be included as part of the configuration of the present disclosure when necessary, and will be described herein without obscuring the spirit of the present disclosure. However, in describing the configuration of the present disclosure, a detailed description on matters that can be clearly understood by those skilled in the art as a known technology prior to the filing date of the present disclosure may obscure the purpose of the present disclosure, so excessively detailed description on the known technology will be omitted.

However, the purpose of the disclosure is not to claim the rights to these known technologies, and the contents of the known technologies may be included as part of the disclosure without departing from the scope of the disclosure.

Hereinafter, exemplary embodiments of the disclosure will be described in more detail with reference to the accompanying drawings. To facilitate an overall understanding in the description of the disclosure, the same reference numerals will be assigned to the same components throughout the accompanying drawings, and redundant descriptions thereof will be omitted.

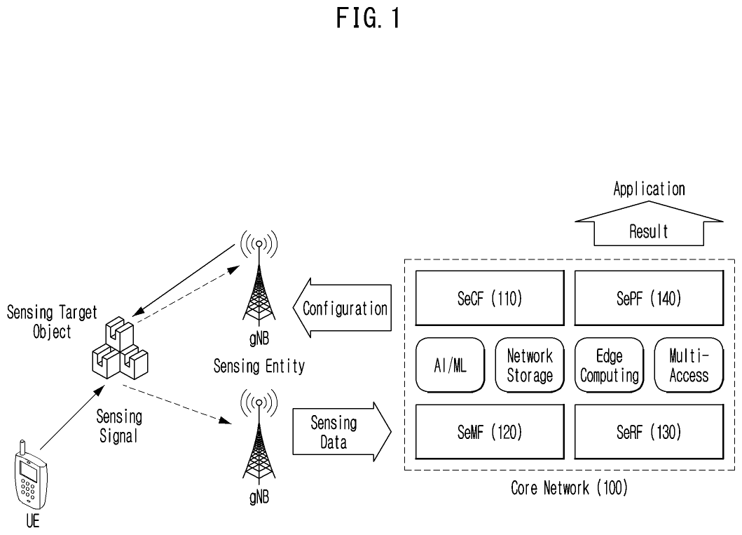

FIG. 1 is a diagram conceptually illustrating a sensing service based on a wireless signal and a core network supporting the service according to an exemplary embodiment of the present disclosure.

For the implementation and operation of the exemplary embodiment of FIG. 1, at least a part of Integrated Sensing and Communication (ISAC) technology may be used, provided that it does not conflict with the objective of the present disclosure.

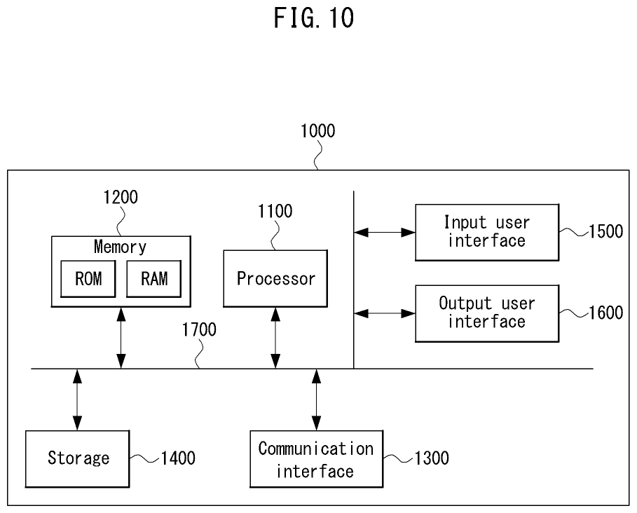

Referring to FIG. 1 and FIG. 10 to be described later, entities in a core network 100 according to an exemplary embodiment of the present disclosure, and/or sensing entities involved in a sensing process by a wireless signal-based sensing service may each include a computer-readable memory 1200 for storing at least one instruction, and a processor 1100 for executing the at least one instruction.

The core network 100 may include various network functions (NFs). Although not illustrated in FIG. 1, the core network 100 may include an Application Function (AF), an Access and Mobility management Function (AMF), an Application Service Provider (ASP), a Location Management Function (LMF), a Network Exposure Function (NEF), an Operation, Administration, and Maintenance (OAM), a Session Management Function (SMF), a Policy Control Function (PCF), a Unified Data Management (UDM), a Unified Data Repository (UDR), a Data Network (DN) or a local part of DN with local access to the data network, a user plane function (UPF), a (Radio) Access Network ((R)AN), and a User Equipment (UE).

Each NF may support the following functions.

The AMF may provide functionality for access and mobility management on a per-UE basis, and one UE may be basically connected to one AMF.

The DN may refer to, for example, an operator service, Internet access, or third-party service. The DN may transmit a downlink protocol data unit (PDU) to the UPF or receive a PDU transmitted from the UE via the UPF. The local part of DN may refer to a data network, which is a part of DN and is locally accessible, with a short data transmission path. The term may refer to a DN where edge application servers supporting edge computing services are deployed.

The PCF may receive information on packet flows from an application server and provide functionality for determining policies such as mobility management and session management. Specifically, the PCF may support functionalities such as providing a unified policy framework for controlling network operations, providing policy rules so that control plane function(s) (e.g. AMF, SMF, etc.) can enforce the policy rules, and implementing a front end for accessing relevant subscription information in the UDR to make policy decisions.

The SMF may provide session management functionality, and when a UE has multiple sessions, the respective sessions may be managed by different SMFs.

The UDM may store user subscription data, policy data, information on the service used by the user, information on the NF serving the user, and the like in the UDR or provide these data to other NFs.

UDR may store, delete, update, and/or provide the user subscription data, policy data applicable to the service used by the user, device configuration information for the user service, service rule information, and the like to other NFs.

The UPF may deliver a downlink PDU received from the DN to the UE via the (R)AN and deliver an uplink PDU received from the UE via the (R)AN to the DN. An uplink classifier (ULCL) may refer to a UPF that has a functionality of classifying uplink traffic for transmission. A local UPF (L-UPF) may serve as a PDU Session anchor for a session transmitted to the local part of DN.

A Sensing Network Function (SNF) may be an NF supporting ISAC (integrated sensing and communication) services. The SNF may perform at least one of receiving an ISAC service request, authenticating the request, generating and configuring ISAC service quality control policies, discovering and selecting network device(s) and terminal(s) performing sensing operations, and collecting and processing sensing results. These operations may be configured or implemented as two logically separated NFs: a Sensing Service Gateway/Centre and a Sensing Management Function.

For example, when configured and implemented as logically separated NFs, the Sensing Service Gateway/Centre may be deployed for the core network to receive and authenticate ISAC service requests and perform operations such as generating ISAC service quality control policies, while the Sensing Management Function may be deployed for the core network to perform operations such as discovering and selecting network device(s) and terminal(s) for performing actual sensing operations and collecting and processing sensing results. The present disclosure does not limit how the Sensing Network Function is configured. That is, both an exemplary embodiment in which the function is configured as a single entity and an exemplary embodiment in which the function is separated into two or more entities are within the scope of the present disclosure. In one embodiment of the present disclosure, at least some of the functions of the Sensing Service Gateway/Centre and/or the Sensing Management Function may be included in the functions of the Sensing Capability Exposure Function (SCEF) and/or the Sensing Service Provisioning Function (SePF), which will be described later.

The UE may be classified into a UE that actually requests an ISAC service and a UE that servers as a sensor detecting a sensing object to provide the ISAC service to the wireless communication system.

A base station of the (R)AN forming a radio access network may perform operations for detecting a sensing object as a sensor, in addition to transmission and reception of communication signals.

To control a quality of an ISAC service according to an exemplary embodiment of the present disclosure, ISAC service quality-related information may be used by the wireless communication system and a device external to the system that requests the ISAC service. To describe exemplary embodiments below, the ISAC service quality-related information may be referred to as ‘Sensing Service Quality (SSQ)’.

Referring again to FIG. 1, the core network 100 according to an exemplary embodiment of the present disclosure may communicate with a sensing apparatus or a sensing device capable of sensing a sensing object (or target) or at least one entity capable of connecting to the sensing device. In this case, the sensing apparatus or the sensing device may be a device separate from a UE or gNB, or may be a UE or gNB itself.

The core network 100 may control, manage, or provide configuration information for sensing devices, as well as configuration information for entities connected to or constituting the sensing devices.

The core network 100 may receive sensing data obtained by the sensing devices through the entities connected to or constituting the sensing devices.

The core network 100 may include a Sensing entity Control network Function (SeCF) 110, a Sensing Management network Function (SeMF) 120, a Sensing Result calculation network Function (SeRF) 130, and a Sensing service Provisioning network Function (SePF) 140.

The core network 100 may provide sensing results obtained using the SeCF 110, the SeMF 120, the SeRF 130, and the SePF 140 to an application. The core network 100 may provide AI/ML, network storage, edge computing, and/or multi-access functionalities using the SeCF 110, the SeMF 120, the SeRF 130, and the SePF 140.

In the present disclosure, the term ‘sensing entity’ may refer to, for convenience of description, an entity connected to or constituting a sensing device and capable of communicating with the core network 100. The sensing entity may be a device separate from the sensing device or the sensing device itself having a sensing functionality.

The sensing entity may be an entity within the (R)AN. The sensing entity may generally be a 3GPP- or 5G/6G-based entity and may also be a non-3GPP entity.

The sensing entity may generally be deployed in a terrestrial communication network, but the sensing entity may also exist in aerial or satellite communication networks.

The sensing entity may transmit sensing information on a sensing object or sensing target to the core network 100 (or to an entity within the core network 100). In this case, if the sensing device is arranged separately from the sensing entity, sensing information from the sensing device may be delivered to the core network 100 via the sensing entity. If the sensing device has a sensing functionality, sensing information obtained by a sensor module implementing the sensing functionality may be transmitted to the core network 100 via a communication module of the sensing entity.

The core network 100 (or an entity within the core network 100) may control or manage a sensing process performed by the sensing entity based on the architecture illustrated in FIG. 1. The sensing entity may include a UE or a gNB, and the core network 100 (or an entity within the core network 100) may control or manage the sensing entity to transmit and receive wireless signals for sensing.

The core network 100 (or an entity within the core network 100) may acquire or receive sensing information on the sensing target by cooperating with the sensing entity or utilizing the sensing entity based on the architecture illustrated in FIG. 1.

The sensing entity/equipment/device in a 3GPP network may be a gNB or UE. A non-3GPP sensing device may be any device using radio access technology not defined in 3GPP (for example, Wi-Fi, or Bluetooth, or the like), a LIDAR, laser, imaging sensor, temperature sensor, or the like.

In the case where the sensing entity is a gNB or UE in the 3GPP network, wireless signals for sensing the sensing target may use 5G NR and/or 6G radio access technologies. However, the spirit of the present disclosure is not limited by such an exemplary embodiment.

The operation of the core network 100 may be performed by the NFs within the core network 100 described above. These NFs may be implemented by at least one entity within the core network 100, may be executed through cooperation between two or more entities, or may be assigned to and implemented by individual entities. The spirit of the present disclosure is not limited by the hardware implementation of these NFs within the core network 100.

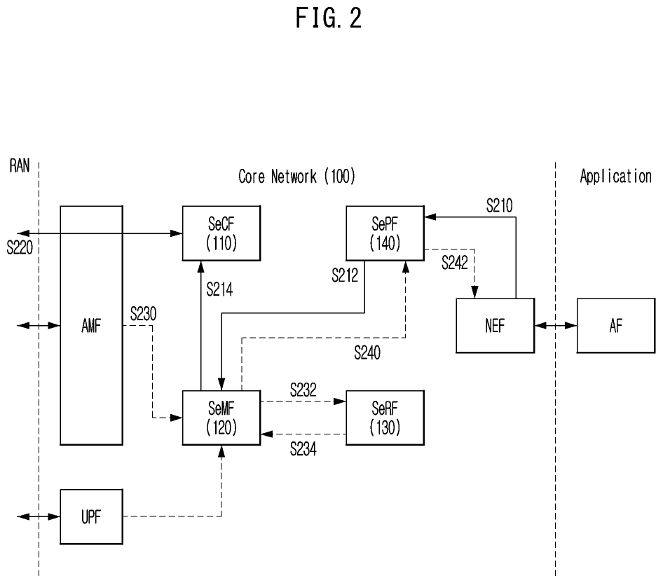

FIG. 2 is a diagram conceptually illustrating an operation of the surrounding infrastructure around the core network shown in FIG. 1.

Referring to FIG. 2, the core network 100 may receive a sensing request from an application/sensing service side (S210).

The core network 100 may control a sensing entity within the RAN to transmit a sensing reference signal for sensing a sensing object (target) within a sensing area (S220).

When the sensing entity within the RAN receives the sensing reference signal, the sensing entity may transmit sensing data to the core network 100 (S230). The core network 100 may process the sensing data received from the sensing entity (S232, S234, S240).

The core network 100 may calculate a sensing result based on the sensing data (S232, S234).

The core network 100 may expose the sensing result (S240).

The core network 100 may provide the sensing result (S242).

The NEF within the core network 100 may receive the sensing request via the AF.

The SePF 140 may receive the sensing request via the NEF (S210).

The SePF 140 may deliver the sensing request to the SeMF 120 (S212).

The SeMF 120 may generate and transmit a sensing trigger to the SeCF 110 based on the sensing request (S214).

In this case, the sensing trigger may include a request for configuration information of sensing devices/sensing entities held by the SeCF 110.

The SeCF 110 may communicate with sensing entities within the RAN via the AMF (S220). In step S220, the configuration information held by the SeCF 110 may be delivered to the sensing entities within the RAN. The information delivered in the step S220 may include sensing configuration/policy information and registration information of sensing devices. The information delivered in the step S220 may be configuration information that enables at least one sensing entity to sense a sensing target.

Additionally or alternatively, the sensing entity may initiate sensing in response to a request from the SeMF 120.

The sensing data obtained by the sensing entity may be delivered to the SeMF 120 via the AMF S230.

In this case, the UPF may also deliver a part of the sensing data to the SeMF 120.

The SeMF 120 may deliver the sensing data to the SeRF 130 (S232), and the SeRF 130 may calculate a sensing result based on the sensing data and provide the sensing result to the SeMF 120 (S234).

The sensing result may be delivered from the SeMF 120 to the SePF 140 (S240).

The sensing result may be provided to the application side via the SePF 140, the NEF, and the AF S242.

The SeCF 110 may select an infrastructure (sensing devices) that will transmit sensing wireless signals and control and configure operations of the sensing devices.

The SeMF 120 may collect, store, and transmit the measured sensing data.

The SeRF 130 may calculate the collected sensing data and generate the sensing result as a result of the calculation. The SeRF 130 may inspect the sensing result and manage a quality of the sensing result.

The SePF 140 may invoke or manage sensing-related integrated services. The SePF 140 may also provide the sensing result to an external application.

The core network 100 according to an exemplary embodiment of the present disclosure may include the following new NFs and procedures.

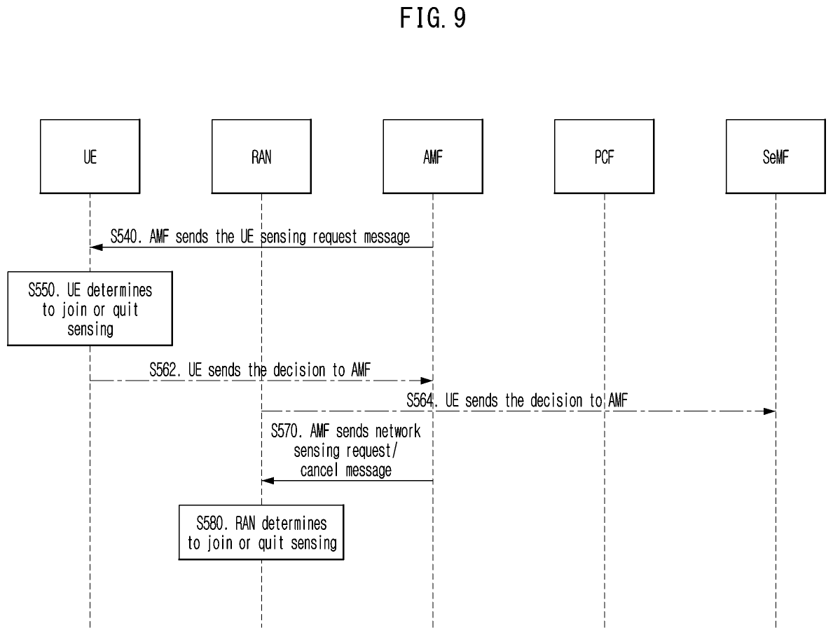

The core network 100 in the exemplary embodiments of FIG. 1 and FIG. 9 to be described later may include the SeCF 110, the SeMF 120, the SeRF 130, and the SePF 140 as new NFs. These NFs are core components for efficiently performing control, processing, calculation, and exposure of sensing data.

The SeCF 110 may define and control the configuration of the sensing entity, the SeMF 120 may collect and pre-process data, the SeRF 130 may analyze the data to generate a result, and the SePF 140 may provide the result to the service. The respective NFs may interact through messages and procedures to manage sensing data in an integrated manner.

The roles of the SeCF 110 may be as follows.

The SeCF 110 may perform configuration and control on the sensing entity. The SeCF 110 may manage a configuration between the sensing entity and the sensing device and may configure the sensing entity and the sensing device in association.

Sensing device control and policy configuration: The SeCF 110 may perform detailed configuration of the sensing device operations in terms of time, space, and range, and may define management and sharing policies.

Sensing device selection: The SeCF 110 may select a device or a device group that is to perform transmission and reception of sensing reference signals. The SeCF 110 may search for and select a sensing entity associated with the sensing device or device group.

The roles of the SeMF 120 may be as follows.

The SeMF 120 may perform collection, coordination, processing, and quality of service (QoS) management of the sensing data. The SeMF 120 may comprehensively manage storage and provision of the sensing data.

The SeMF 120 may instruct the sensing entity to perform a sensing operation and may coordinate and manage the sensing operation.

Sensing control flow management: The SeMF 120 may comprehensively manage the sensing control and operation invocation.

Sensing data management: The SeMF 120 may store, manage, and provide sensing data (including raw data), and may evaluate and manage the accuracy and response time of the data. The SeMF 120 may collect and coordinate the sensing data and may manage the quality of the sensing data based on QoS.

Sensing method selection: The SeMF 120 may map a sensing target object and a sensing area and may select an optimal sensing method for the sensing target object and the sensing area.

The roles of the SeRF 130 may be as follows.

Sensing result calculation: The SeRF 130 may process sensing data and derive a result by applying filtering and mapping.

Result validity evaluation: The SeRF 130 may validate the sensing result and manage a quality of the result. In this case, the SeRF 130 may evaluate and manage the accuracy and response time of the sensing result for quality management.

The roles of the SePF 140 may be as follows.

The SePF 140 may manage a service request and monitor event condition(s) included in the service request.

The SePF 140 may map the sensing result according to the service request and perform authentication and authorization for the service request.

Service request and authentication: The SePF 140 may manage the service request and authenticate and authorize the corresponding request.

Sensing data exposure: The SePF 140 may map the service request and the sensing result and provide them to an application service while maintaining security. The SePF 140 may maintain the security of the sensing data and sensing result and manage privacy.

Through the interaction of these NFs, the core network 100 may integrally manage the processes of sensing data request, control, processing, calculation, exposure, and response. To this end, the NFs may interact through messages and procedures. The core network 100 according to exemplary embodiments of the present disclosure may overcome the limitations of the 5G system and maximize the efficiency of ISAC technology.

An alternative exemplary embodiment of the core network according to the present disclosure may further include a Network Data Analytics Function (NWDAF). The NWDAF may support AI-based analysis. The NWDAF may support preprocessing of sensing data, optimization of device configuration, and improvement of result calculation efficiency by using AI algorithms.

The NWDAF may generate QoS enhancement information by analyzing the data provided by the sensing entity. The QoS enhancement information may be delivered to the SeMF 120 and the SeRF 130 to enhance the efficiency of data processing and result calculation.

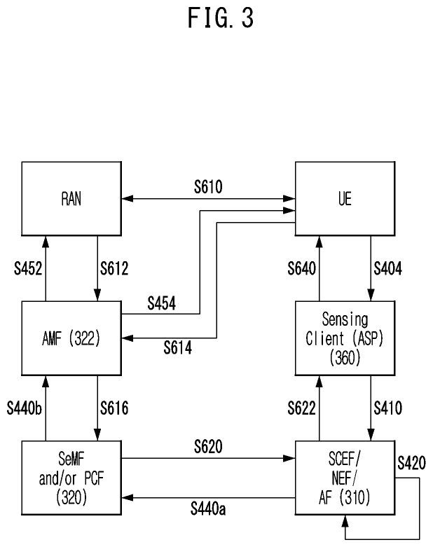

FIG. 3 is a diagram conceptually illustrating a method for controlling sensing on a target sensing area according to an exemplary embodiment of the present disclosure.

As a wireless band of a mobile communication system is extended to higher frequency bands, a bandwidth increases and propagation characteristics of radio waves become more sensitive. By utilizing the propagation or reflection characteristics of mobile communication radio waves, it is possible to identify a position, shape, and components of a specific object. The present disclosure relates to a sensing technology utilizing such radio waves.

The present disclosure provides an effective mobile communication system architecture and control method for performing sensing and has been derived with the objective of improving the accuracy of radio wave/signal-based sensing.

Referring to FIG. 3, a core network that performs a method for controlling sensing on a target sensing area according to an exemplary embodiment of the present disclosure may include at least a first NF 310 and one or more second NFs, such as NF 320 and/or NF 322, of FIG. 3.

A sensing client 360 may communicate with a UE and may communicate with the core network via the first NF 310 since some of the functions of the sensing client 360 are implemented in the UE as form of Apps. The sensing client 360 may include an ASP NF.

The first NF 310 may include at least one of an SCEF, an NEF, and/or an AF. In alternative embodiment of the present disclosure, the first NF 310 may include some of functions of SePF 140 disclosed in the FIGS. 1 and 2.

The second NFs 320 and 322 may include a first part 320 corresponding to the SeMF and/or a PCF and a second part 322 corresponding to an AMF.

In the alternative embodiment of the present disclosure, the first part 320 corresponding to the second NFs and/or the PCF may include the functions of the SeCF 110, SeMF 120, and SeRF 130 separated from the embodiments disclosed in FIG. 1 and FIG. 2, and the first part 320 may be expressed in a form in which these are implemented as one network function.

The second NFs 320 and 322 may further include a UDR and/or a Unified Data Management (UDM).

A method for controlling sensing on a target sensing area according to an exemplary embodiment of the present disclosure may comprise: step S410 in which the sensing client 360 transmits a sensing request including sensing rule information to be applied to the target sensing area to the core network; step S420 in which the core network converts the sensing rule information into an information element for one or more second NFs 320 and/or 322 within the core network using at least one first NF 310; step S440, S440a, or S440b in which the core network determines a sensing entity to perform a sensing operation corresponding to the sensing request based on the information element using the one or more second NFs 320 and/or 322; and step S452 or S454 in which the core network requests a sensing operation of the sensing entity.

In this case, the sensing rule information may include sensing rule information specialized for each target sensing area.

In the method for controlling sensing on a target sensing area according to an exemplary embodiment of the present disclosure, the sensing rule information may include identification information of the target sensing area and identification information of a sensing profile specialized for the target sensing area.

In the method for controlling sensing on a target sensing area according to an exemplary embodiment of the present disclosure, the sensing rule information may include a designated sensing time, sensing measure time intervals, desired sensing resolution, preferred sensing access techniques, or a preferred sensing mode.

In the method for controlling sensing on a target sensing area according to an exemplary embodiment of the present disclosure, the sensing rule information may include a target sensing object, sensing objectives, a sensing event set, a list of candidate UEs for sensing, a group identifier (ID), or an application ID.

The mapping process in step S420 may be performed with reference to Table 1 below.

TABLE 1

| Sensing rules from ASP | Information element for NF |
|---|---|
| External Application ID | Internal Application ID |
| Sensing Profile ID | Sensing Profile ID |
| Sensing objectives | (A set of Sensing) Event ID(s) |
| Sensing Transaction ID | Service Transaction ID |
| Target Sensing Area | List of cell ID or |
| (Geographic zone id) | List of tracking area identity |
| Designated Sensing Time | (Sensing or Event) Reporting |
| (start, end) | information or time stamp |
| Sensing Measure Time Interval | Sensing interval |
| Desired Sensing Resolution | Resolution level ID |
| (High, Medium, Low) | |
| A List of Candidate UEs | GPSI or SUPI |
| (e.g. GPSI) | |
| External Group ID | Internal Group ID |
| Preferred sensing | Access type |
| access technique | |
| Preferred sensing mode | (A list of) Sensing Mode ID |
| Target sensing object | Object ID or Object Type ID |

Referring again to FIG. 3, a sensing system may include one or more UEs, RAN(s), the AMF 322, the SeMF and/or PCF 320, the sensing client 360, and/or the first NF 360, and the like.

The UE may be a client of a sensing application that requests sensing, or may be a sensing entity that participates in sensing to make a sensing request. The UE may participate in sensing for a sensing service that the UE itself requested. In this case, the UE may be located within a specific target area designated by the sensing request. The UE may participate in sensing for a sensing service requested by another UE and may provide sensing measurement results.

The sensing client 360 may receive the sensing request from the UE S404. In this case, the UE may be a client of the sensing application that requests sensing.

The UE may transmit processed measurements (for example, events that may be estimated from measured data, such as movement of a sensing target exceeding a certain category/range or the shape of a sensing target) or unprocessed measurements (for example, measured raw data) to the sensing client 360 as a sensing entity.

The sensing client 360 may include within itself a sensing measurement analyzer function or may interact with a sensing measurement analyzer function to process sensing measurements. For example, an ASP of the sensing client 360 may deliver a set of processed/unprocessed measurements to the sensing measurement analyzer, and the sensing measurement analyzer may deliver an analysis result to an application layer. If the UE is a client of the application or service, the analysis result may be delivered to the UE.

The ASP within the sensing client 360 may deliver the sensing request along with requirements for the sensing to the first NF 310 (S410).

The first NF 310 may deliver a set of processed/unprocessed measurements collected from sensing entities other than the UE shown in FIG. 3 to the sensing measurement analyzer within the sensing client 360 (S622).

When the UE shown in FIG. 3 is a client of the sensing service, the sensing client 360 may provide the analysis result of the sensing measurement analyzer to the UE as a response to the sensing request of step S404 (S640).

In an alternative exemplary embodiment of the present disclosure, the sensing client 360 may deliver a configuration information for sensing to the UE. For example, configuration information may be transmitted in advance and/or in real time through a sensing application of a sensing client installed on the UE. In this case, the configuration information for sensing may refer to a configuration information for sensing the specific target area determined based on the sensing request to be performed by the sensing client 360. The UE may determine whether to participate in sensing as a sensing entity based on the configuration for sensing.

The first NF 310 may include the SCEF, the AP, and/or the NEF. The sensing request and the requirements for the sensing transmitted by the sensing client 360 in step S410 may be received by the AF. The AF may deliver the sensing request and the requirements for the sensing to the NEF so that they are processed within the core network. The NEF may deliver a sensing result for the specific target area processed within the core network, i.e. a set of processed/unprocessed measurements, to the AF, and the AF may deliver the set of processed/unprocessed measurements to the sensing client 360 (S622).

The NEF within the first NF 310 may deliver the sensing request and the requirements for the sensing to the SeMF and/or the PCF 320 among the second NFs 320 and 322 (S440a).

The SeMF and/or the PCF 320 may provide the set of processed/unprocessed measurements for the specific target area to the NEF (S620).

The SeMF and/or the PCF 320 may transmit a set of sensing configuration information, sensing policy, target sensing agent, etc. to the AMF 322 along with the sensing request (S440b). In this case, the SeMF and/or the PCF 320 may acquire, determine, or generate information to be transmitted in step S440b in cooperation with the SeCF 110 of FIGS. 1 and 2.

The SeMF and/or the PCF 320 may receive the processed/unprocessed measurements from the AMF 322 (S616). The SeMF and/or the PCF 320 may acquire a set of processed/unprocessed measurements by processing/handling the sensing results from the various sensing entities using a sensing measurement synthesis and analyzer function. In this case, the SeMF and/or the PCF 320 may cooperate with the SeRF 130 or the NWDAF of FIG. 1 and FIG. 2 to acquire the set of processed/unprocessed measurements.

The AMF 322 may transmit sensing entity configuration/control information provided from the SeMF and/or the PCF 320 or from the SeCF 110 of FIGS. 1 and 2 to the UE or the RAN (S452, S454). The information transmitted to the UE or the RAN in steps S452 and S454 may also include the sensing request for the specific target area.

The AMF 322 may receive the processed/unprocessed measurements from the RAN or the UE (S612, S614).

The UE and the RAN may transmit and receive sensing reference signals and/or sensing measurement results with each other (S610).

The UE and the RAN may be provided with sensing reference signal transmitter (Tx)/receiver (Rx) modules. The RAN may utilize various access techniques such as Wi-Fi, New Radio (NR), E-UTRA, or 6G Radio for transmission and/or reception of sensing reference signals. When the UE transmits a sensing reference signal, the UE may operate like a RAN with respect to other UEs. The RAN and the UE may include sensing signal analyzers/transporters. In this case, the sensing signal analyzers/transporters may derive meaningful results corresponding to the request by the sensing application or may provide raw measurements to the ASP of the sensing client 360. The sensing results may be directly provided through a user plane or may be provided through a control plane of the core network including the SeMF and/or the SCEF, or the like.

The SeMF may function as a standalone NF or an integrated logical component within the PCF or the LMF in a cellular system. The SeMF may implement a sensing request in the cellular system and may synthesize and analyze sensing measurement results of the UE and the RAN.

According to an exemplary embodiment of the present disclosure, the sensing client 360 may initiate wireless sensing for a designated area according to a request of a sensing application of the UE or when the ASP identifies a need for sensing in the corresponding area. The sensing client 360 may be an application service including applications of mobile network operators (MNOs) or third-party applications, or may be the cellular system itself. The sensing client may be equipped with a sensing measurement analyzer to analyze all sensing measurements collected from the designated area.

When the sensing client 360 determines that the sensing may be required for a specific area, the sensing client 360 may deliver sensing requirements to the AF and the sensing application of the UE through the SCEF and the user plane (e.g., GTP tunnel), respectively. The sensing requirements may include potential sensing modes, required access techniques, sensing reference signal intervals, sensing targets (e.g., UE-to-UE, UE-to-RAN, the RAN itself, and the UE itself), and sensing activation conditions (e.g., specific area, sensing start time, sensing end time, etc.).

Based on the delivered information, when the sensing application determines that the UE satisfies the sensing activation condition or when the UE intends to manually activate sensing, this determination may be delivered to the ASP or the sensing client through the user plane. The ASP receiving the determination may forward a sensing request containing sensing requirements to the core network. When the core network receives the sensing request, the AF or the NEF may convert the sensing requirements (included in the sensing request) and the sensing activation condition into a specific service and parameters of the cellular network. The converted information may be delivered to the SeMF and/or the UDR.

The sensing process according to an exemplary embodiment of the present disclosure may activate wireless sensing within a specific target area through the cellular system.

According to an exemplary embodiment of the present disclosure, the UE, MNO, or ASP may trigger a cellular sensing service through the sensing client 360 for various purposes such as network optimization, UE mobility tracking, functional support or enhancement of smartphone applications using sensing measurements.

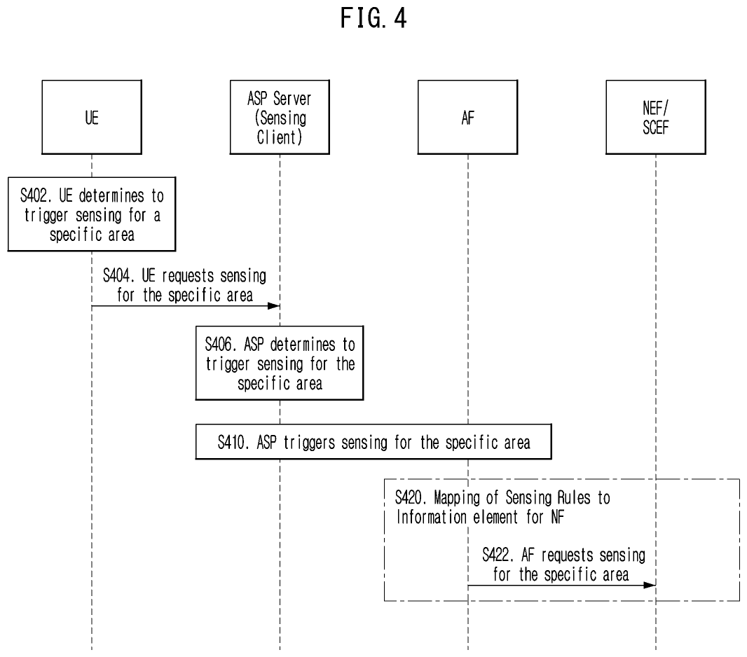

The sensing client 360 may initiate a request to the cellular system to activate wireless sensing for a designated area. Subsequently, the cellular system may implement policies and configurations for the sensing request. Such implementation may be described with reference to FIGS. 4 to 7.

In an approach in which a sensing would be initiated by the ASP (or the sensing client), the ASP may activate a cellular sensing service by utilizing various data collected from the cellular network. The collected data may include information such as an analysis or analysis set provided by the NWDAF, UE mobility, communication patterns, network performance, distribution, and network load, as well as information of the UE including but not limited to GPS location, application data, and Wi-Fi signal strength.

The ASP may use such information to activate the cellular sensing service while designating a sensing target area by utilizing the cellular SCEF through the AF and the NEF.

In a scenario in which a sensing application installed in the UE requests initiation of sensing of the ASP or the sensing client, the ASP may configure a condition for the UE to directly activate the cellular sensing service through a client application. The application may be installed by the user or pre-installed in the UE by the manufacturer or the MNO. The client app may provide the UE with a capability to adjust the condition for activating the cellular sensing service according to an embedded application logic. Accordingly, the UE may independently trigger the cellular sensing service.

FIGS. 4 to 7 are sequence diagrams illustrating processes for a method of controlling sensing on a target sensing area according to an exemplary embodiment of the present disclosure.

Referring to FIGS. 4 to 7, a detailed procedure for activating cellular sensing through interactions among a UE, an ASP server (sensing client), and an OAM is disclosed.

Referring to FIG. 4, based on a configuration of a UE sensing application of the sensing client or a manual request from a user, the UE may determine to initiate a cellular sensing service for a specific area adjacent to the UE (S402). The UE may transmit the determined sensing request to the ASP server through a user plane (S404).

When the ASP server receives the sensing request from the UE (S402, S404), or when the ASP server identifies a need for cellular sensing by itself, the ASP server may determine to activate the cellular sensing service (S406).

The ASP server may determine sensing rules. The sensing rules may include at least one of the following elements. For example, the sensing rules may include a target sensing area, a designated sensing time (start, end), sensing measurement time intervals, required sensing resolution, a target sensing object, sensing objectives, preferred sensing access techniques, a preferred sensing mode, a list of candidate UEs for sensing, a group identifier (ID), an application ID, and the like.

When a service level agreement exists between the ASP and the MNO, a contracted sensing profile ID may be used to indicate the sensing rules.

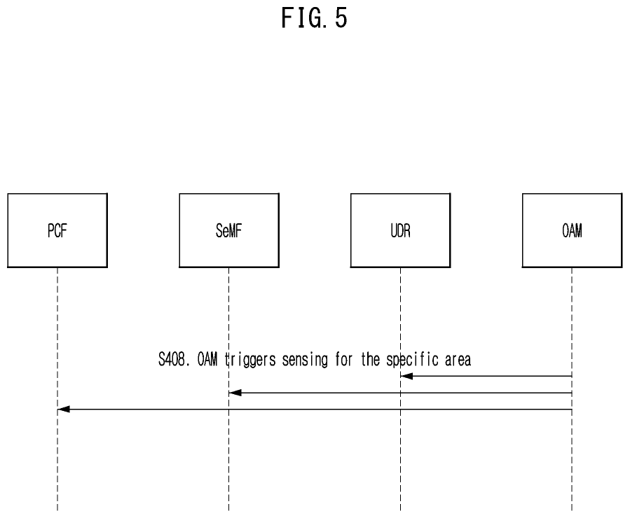

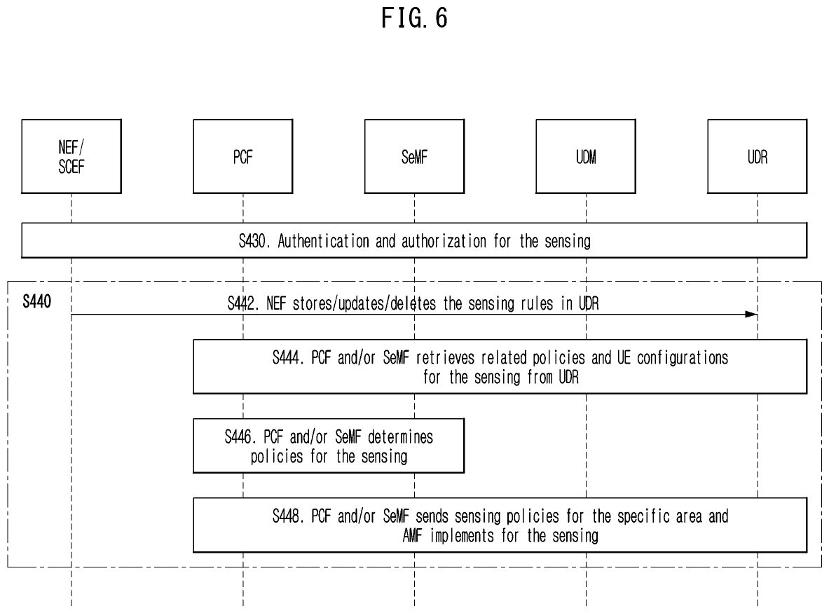

Referring to FIG. 5 according to an alternative exemplary embodiment of the present disclosure, when the MNO selects to activate a cellular sensing service, the OAM may instruct the PCF and/or the SeMF and/or the UDR to configure and enforce a cellular sensing policy (S408). When step S408 is activated, steps S402 to S420 and steps S430 through S442 (some of the steps will be described in FIG. 6) may be replaced by step S408.

Referring again to FIG. 4, the ASP may transmit the sensing rules defined in step 406 to the AF (S410).

The AF and/or the NEF/SCEF may select one or more NF services within the cellular network to fulfill the requested sensing service. The AF and/or the NEF/SCEF may convert the sensing rules into information element(s) suitable for implementation of the NF services, as described in Table 1 above (S420).

As a part of step S420, or to support step S420, the AF may deliver the sensing request for the specific target area to the NEF/SCEF (S422). Alternatively, step 422 may be performed independently of the step 420.

Referring to FIG. 6, the NEF/SCEF or the PCF may evaluate authentication and authorization for the sensing request of the preceding step (S430).

Authentication and authorization information related to the sensing request from the ASP may be pre-defined in the NEF according to the service level agreement between the MNO and the ASP, or may include application service and UE subscription data, and may be stored in the UDR.

The NEF/SCEF or the PCF may evaluate the accessibility of the requested sensing area using configured information and/or data in the UDR.

Based on the sensing request, the NEF/SCEF may determine whether to store, update, or delete the sensing rules in the UDR (S442).

In step S444, the PCF and/or the SeMF may subscribe to updates of UDR data related to the sensing rules, and the UDR data may include application service-related data and/or UE subscription data. Upon receiving a notification related to data changes from the UDR, the PCF and/or the SeMF may acquire the updated sensing rules and related data. According to the service level agreement, a local data network name (DNN) may be configured in the UDR along with available area information (for example, tracking area list, cell id, or the like).

In step S446, the PCF and/or the SeMF may establish all policies related to the requested sensing by utilizing the data retrieved from the UDR in step S444 and may identify a target for policy application. This process may also include selecting related NFs and UEs within the requested sensing area.

To this end, the PCF and/or the SeMF may acquire NF profiles of target NFs, including serving areas of the NFs such as AMF, from the NRF through an NF discovery service. After acquiring the NF profiles of the target NFs, the PCF and/or the SeMF may select the AMF that covers the requested sensing area as the serving area.

The PCF and/or the SeMF may subscribe to a service capable of getting UE locations of the LMF or AMF to receive updates on UE locations, so as to select UEs within the requested area from the list of candidate UEs transmitted by the AF.

In step S448, the PCF and/or the SeMF may transmit new policies and/or sensing requests to the AMF selected in step S446 to enforce the defined policies throughout the cellular network.

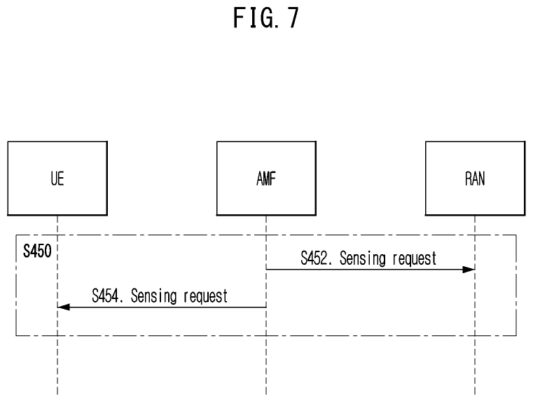

When the AMF receives the sensing request, the AMF may deliver the sensing request to the related RAN and/or UE, and may enable the sensing request to be performed by the sensing entities, as illustrated in FIG. 7 (S450).

When the local DNN is associated with specific area information where the corresponding DNN may be used, the AMF may deliver such information to the UE that is registered in the area where the local DNN may be used or identified as a sensing entity candidate would be newly registered through a registration procedure.

Referring to FIG. 7, the AMF may transmit a sensing request including sensing configuration details (e.g. sensing interval, resolution, reporting period, target area, etc.) to a target RAN within the designated area (S452). Step S452 may be achieved using an N2 delivery service for message transmission.

The AMF may transmit the sensing request to the target UE (S454). In this case, the sensing request transmitted in step S454 may include sensing configuration details such as sensing interval, resolution, reporting period, reporting method, S-NSSAI for sensing, and specific local DNN, and the sensing configuration details may also include available sensing methods such as 3GPP, Non-3GPP, RAN type, reflected path, or direct path.

In this case, an N1 delivery service may be utilized for the transmission of the sensing request message in the step 454.

Referring again to FIG. 6, in the method for controlling sensing on a target sensing area according to an exemplary embodiment of the present disclosure, step S440 of determining the sensing entity may include step S448 of acquiring information on an AMF NF related to the sensing entity based on the information elements.

In this case, step S440 of determining the sensing entity may further include a step of selecting the sensing entity from a list of candidate UEs located in the target sensing area.

In step S440 of determining the sensing entity, the sensing entity may be determined based on the information elements by using sensing policy or UE configuration information obtained from the UDR (S444, S446).

Step S440 of determining the sensing entity may include step S442 of determining whether to store, update, or delete the information element corresponding to the sensing rule information in the UDR.

Referring again to FIG. 4, in the method for controlling sensing on a target sensing area according to an exemplary embodiment of the present disclosure, step S410 of transmitting the sensing request to the core network by the sensing client may include step S406 for the sensing client to determine whether to transmit the sensing request for the target sensing area to the core network based on the sensing trigger request received from the UE in step S404.

Referring again to FIG. 7, in the method for controlling sensing on a target sensing area according to an exemplary embodiment of the present disclosure, step S450 of the core network requesting a sensing operation of the sensing entity may include a step of transmitting information on the target sensing area to the sensing entity, and a step of transmitting sensing interval, resolution, or reporting period as configuration details for the sensing request to the sensing entity.

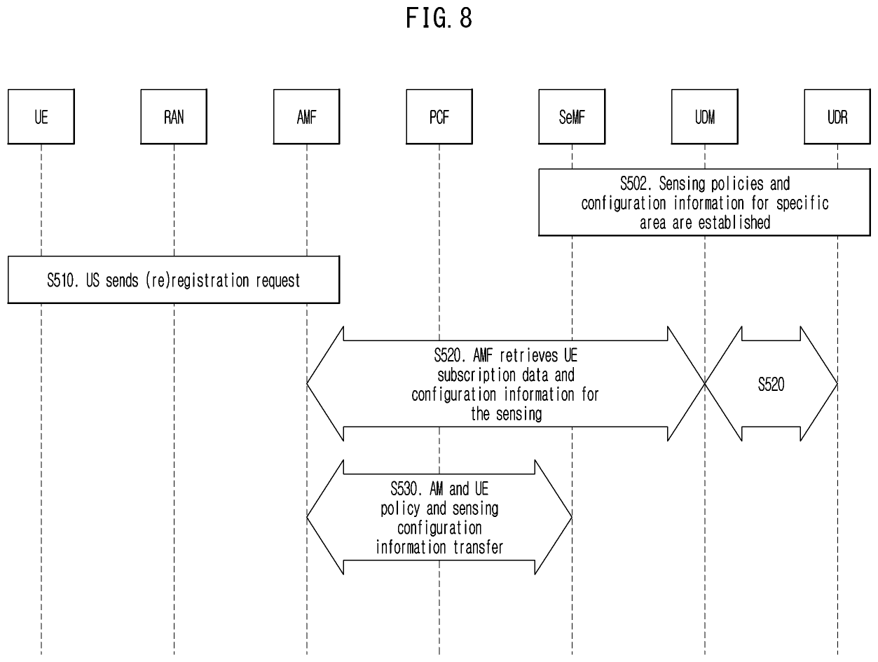

FIGS. 8 and 9 are sequence diagrams illustrating processes for a method of managing a UE for sensing a target sensing area according to another exemplary embodiment of the present disclosure.

When cellular sensing is activated as in the exemplary embodiments of FIGS. 3 to 7, the UE may have flexibility to dynamically participate in or withdraw from sensing measurements based on its mobility and willingness to participate in sensing activities, as illustrated in FIGS. 8 and 9.

When a target UE registers with the AMF, the AMF may transmit sensing configuration details including a designated target sensing area. As a result, the UE may evaluate whether to participate in sensing based on the configuration information provided by the AMF and may verify its own location.

The AMF may have a functionality of monitoring mobility and accurate location of the UE through an LCS system. By using the location monitoring functionality, the AMF may request sensing from the target UE only when the target UE is located within the designated sensing area. When the UE leaves the target area, the UE may immediately stop the sensing operation and submit the collected measurements by the corresponding UE.

Referring to FIGS. 8 and 9, a process in which the AMF initiates a sensing request targeting a UE and a RAN is disclosed in detail.

In step S502, sensing policies and configuration information for a specific target area may be established. This process may refer to the exemplary embodiments of FIGS. 3 to 7 described above.

In step S510, the UE may transmit a (re) registration request due to expiration of a registration timer or movement outside a provisioned registration area. The request in step S510 may include an indication of a possible sensing operation, and this indication may be understood as expressing an intent of the UE to participate in a sensing service.

When the UE opts out of the sensing service, the indication may be deactivated in the (re) registration request. If the (re) registration request does not include an indication of available or possible sensing operation, the AMF may abandon sensing-related information regarding the UE.

When the AMF receives the registration request in step S510, the AMF may retrieve one or more of UE subscription data, access and mobility subscription data, a sensing operation indicator, sensing request-related data, and configuration information from the UDM (S520). Thereafter, the UDM may retrieve the information from the UDR (S520).

When a sensing operation indicator is included in the (re) registration request message of step S510, the AMF may record the sensing operation indicator in the UDR through the UDM, and by recording the sensing operation indicator in the UDR, all AMFs may recognize the UE's interest or intent regarding sensing, even if the AMF connected to the UE changes due to mobility.

The AMF may retrieve access and mobility policies and sensing-related rules using the PCF and/or the SeMF (S530). The information retrieved/acquired/provided in step S530 may include at least one of a target area for sensing, a measurement reporting method, start and end times of the sensing service, sensing duration, sensing reference signal requirements, available access techniques (e.g. eUTRAN, NR, NTN access, Non-3GPP access), sensing resolution, sensing interval, or a combination thereof.

Referring to FIG. 5, the AMF may transmit configuration information and sensing-related data to the UE (S540) so that the UE can measure sensing reference signals.

Based on the configuration and sensing information received in step S540, the UE may determine whether to participate in or withdraw from the sensing request (S550). If the UE is located within the designated sensing area, the UE may select to participate in the sensing operation. Otherwise, the UE may withdraw its intent to participate in the sensing operation. When the UE determines to participate, the UE may transmit, receive, measure, and process sensing reference signals for the sensing.

The UE may transmit to the AMF the determination on whether to participate in the sensing operation (S562). Upon receiving the determination of the UE (S562), the AMF may activate or suspend a sensing operation within the RAN according to the selected sensing mode and may transmit the determination to the SeMF (S564). As a result, the SeMF may evaluate available measurements and may synthesize measured/evaluated/analyzed information as sensing results for the designated area.

The AMF may transmit RAN configuration information and sensing-related information to the RAN to support the RAN in transmitting and measuring sensing reference signals (S570).

Based on the RAN configuration and sensing information transmitted in step S570, the RAN may determine whether to participate in the sensing in response to the sensing request (S580).

Based on the RAN configuration and sensing information transmitted in step S570, the RAN may appropriately transmit, receive, measure, and process sensing reference signals to respond to the sensing request.

When the UE or the RAN completes sensing reference signal measurements, the UE or the RAN may transmit either processed raw measurement data or unprocessed raw measurement data to the SeMF and/or the ASP.

Thereafter, the SeMF and/or the ASP may compile respective measurement reports from various RANs and UEs, organize the data based on a sensing transaction ID, and process the data into meaningful sensing results using parameters such as sensing time and location.

Referring again to FIGS. 8 to 9, a method for managing a UE for sensing on a target sensing area according to another exemplary embodiment of the present disclosure may comprise: a step in which the core network converts sensing rule information to be applied to a target sensing area, which is included in a sensing request received from a sensing client, into information element(s) for one or more second NFs within the core network using at least one first NF; a step in which the core network stores and manages the information element(s) in a UDR using the one or more second NFs; a step in which the core network determines a UE as a candidate sensing entity for the sensing request based on a sensing entity registration request received from the UE using the one or more second NFs; and a step in which the core network transmits a sensing request message to the UE to request a sensing operation for the sensing request.

The first NF may include the AF, NEF, and/or SCEF.

The second NF may include the AMF, PCF, SeMF, UDM, and/or UDR.

In the method for managing a UE for sensing on a target sensing area according to another exemplary embodiment of the present disclosure, the sensing rule information may include identification information of the target sensing area and identification information of a sensing profile specified for the target sensing area. The sensing rule information may also include a designated sensing time, sensing measurement time intervals, a sensing resolution, a preferred sensing access technique, a preferred sensing mode, a target sensing object, sensing objectives, or a sensing event set.

The sensing entity registration request may include information regarding a change of the AMF NF of the UE due to a change in mobility of the UE.

In the above-described exemplary embodiment, sensing policies/sensing rules/information elements per specific target area have been described as being defined per application, but exemplary embodiments of the present disclosure are not limited thereto.

In an alternative exemplary embodiment of the present disclosure, sensing policies/sensing rules/information elements per specific target area may be defined per object, UE, or sensing entity in addition to per application.

According to exemplary embodiments of the present disclosure, network functions and procedures for implementing sensing based on wireless signals can be implemented.

According to exemplary embodiments of the present disclosure, a method of performing sensing by utilizing UE(s) within a specific area and a system architecture for controlling and managing the same are proposed, thereby enabling improvement in sensing accuracy.

According to exemplary embodiments of the present disclosure, a procedure for initiating sensing on a specific target area in a mobile communication system, information elements required to initiate the sensing, a method for controlling sensing on the specific target area in the mobile communication system, and a network system architecture for supporting the same can be implemented.

According to exemplary embodiments of the present disclosure, all devices or entities capable of performing sensing within a specific target area can be recognized and/or utilized, thereby can be enabled to join in sensing within the specific target area.

According to exemplary embodiments of the present disclosure, group sensing based on cooperation among sensing devices or sensing entities within a specific target area can be provided, and group sensing results measured at a plurality of sensing device and entities within the specific target area can be gathered and be processed, thereby enabling improvement in sensing accuracy within the specific target area.

FIG. 10 is a conceptual diagram illustrating an example of a generalized computing system in which an entity within the core network 100 capable of performing at least part of the processes of FIGS. 1 to 9, a sensing entity participating in a sensing process by interacting with the core network 100, or a part thereof is implemented.

In exemplary embodiments of the present disclosure, at least a part of sensing, control, computation, data processing, data transmission, and data reception performed by an entity executing at least part of the NFs within the core network 100 and a sensing entity involved in the sensing process for a target may be executed by the computing system 1000 of FIG. 10.

Referring to FIG. 10, the computing system 1000 according to an exemplary embodiment of the present disclosure may include a processor 1100, a memory 1200, a communication interface 1300, a storage device 1400, an input interface 1500, an output interface 1600, and a bus 1700.

The computing system 1000 according to an exemplary embodiment of the present disclosure may include the at least one processor 1100 and the memory 1200 that stores instructions causing the at least one processor 1100 to perform at least one step. At least a portion of the steps of the method according to an exemplary embodiment of the present disclosure may be performed by the at least one processor 1100 that loads the instructions from the memory 1200 and executes the instructions.

The processor 1100 may refer to a central processing unit (CPU), a graphics processing unit (GPU), or a dedicated processor on which the methods according to the exemplary embodiments of the present disclosure are performed.

Each of the memory 1200 and the storage device 1400 may include at least one of a volatile storage medium and a non-volatile storage medium. For example, the memory 1200 may include at least one of a read-only memory (ROM) and a random access memory (RAM).

The computing system 1000 may further include the communication interface 1300 for performing communication through a wireless network.

The computing system 1000 may further include the storage device 1400, the input interface 1500, and the output interface 1600.

The respective components included in the computing system 1000 may communicate with one another by being connected via the bus 1700.

According to an exemplary embodiment of the present disclosure, a communication network system that controls sensing on a target sensing area may include at least one entity, and the at least one entity may include: a computer-readable memory 1200 that stores at least one instruction; and a processor 1100 that executes the at least one instruction.

The at least one entity may receive a sensing request from a sensing client, the sensing request including sensing rule information to be applied to the target sensing area, may convert the sensing rule information into an information element for at least one second network function using at least one first network function, may determine a sensing entity to perform a sensing operation corresponding to the sensing request based on the information element using the at least one second network function, and may request the sensing operation of the sensing entity.

In the communication network system that controls sensing on a target sensing area according to an exemplary embodiment of the present disclosure, the sensing rule information may include sensing rule information specialized for the target sensing area.

In the communication network system that controls sensing on a target sensing area according to an exemplary embodiment of the present disclosure, the sensing rule information may include identification information of the target sensing area and identification information of a sensing profile specialized for the target sensing area.

In the communication network system that controls sensing on a target sensing area according to an exemplary embodiment of the present disclosure, the sensing rule information may include a designated sensing time, sensing measurement time intervals, a sensing resolution, a preferred sensing access technique, or a preferred sensing mode.

In the communication network system that controls sensing on a target sensing area according to an exemplary embodiment of the present disclosure, the sensing rule information may include a target sensing object, sensing objectives, a sensing event set, a list of candidate UEs for sensing, a group ID, or an application ID.

In the communication network system that controls sensing on a target sensing area according to an exemplary embodiment of the present disclosure, the at least one entity may acquire information on an AMF NF related to the sensing entity based on the information element in order to determine the sensing entity.

The at least one entity may select the sensing entity from among a list of candidate UEs located within the target sensing area in order to determine the sensing entity.

When requesting the sensing operation of the sensing entity, the at least one entity may transmit information of the target sensing area to the sensing entity and may transmit sensing interval, resolution, or reporting period as configuration details for the sensing request to the sensing entity.

An example of the computing system 1000 of the present disclosure may include a communicable desktop computer, laptop computer, notebook, smartphone, tablet PC, mobile phone, smart watch, smart glasses, e-book reader, portable multimedia player (PMP), portable gaming device, navigation device, digital camera, digital multimedia broadcasting (DMB) player, digital audio recorder, digital audio player, digital video recorder, digital video player, or personal digital assistant (PDA), and/or the like.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of controlling sensing on a target sensing area, comprising:
transmitting, by a sensing client, a sensing request including sensing rule information to be applied to the target sensing area to a core network;
determining, by the core network, a sensing entity to perform a sensing operation corresponding to the sensing request based on the information element corresponding to the sensing rule information using at least one network function; and
requesting, by the core network, a sensing operation of the sensing entity,
wherein the sensing rule information includes sensing rule information specialized for the target sensing area.

2. The method according to claim 1, wherein the sensing rule information includes identification information of the target sensing area and identification information of a sensing profile specialized for the target sensing area.

3. The method according to claim 1, wherein the sensing rule information includes a designated sensing time, sensing measurement time intervals, a sensing resolution, a preferred sensing access technique, or a preferred sensing mode.

4. The method according to claim 1, wherein the sensing rule information includes a target sensing object, sensing objectives, a set of sensing events, a list of candidate user equipments (UEs) for sensing, a group identifier (ID), or an application ID.

5. The method according to claim 1, wherein the determining of the sensing entity comprises: acquiring information on an Access and Mobility Management (AM) network function related to the sensing entity based on the information element.

6. The method according to claim 5, wherein the determining of the sensing entity comprises: selecting the sensing entity from a list of candidate UEs located within the target sensing area.

7. The method according to claim 1, wherein in the determining of the sensing entity, the sensing entity is determined based on the information element by using a sensing policy or UE configuration information obtained from a Unified Data Repository (UDR).

8. The method according to claim 1, wherein the determining of the sensing entity comprises: determining whether to store, update, or delete the information element corresponding to the sensing rule information in a UDR.

9. The method according to claim 1, wherein the transmitting of the sensing request comprises: determining, by the sensing client, whether to transmit the sensing request for the target sensing area to the core network based on a sensing trigger request received from a UE.

10. The method according to claim 1, wherein the requesting of the sensing operation comprises:
transmitting, to the sensing entity, information of the target sensing area; and
transmitting, to the sensing entity, sensing interval, resolution, or reporting period as configuration detail information for the sensing request.

11. A communication network system comprising: at least one entity, wherein the at least one entity comprises:
a computer-readable memory storing at least one instruction; and
a processor executing the at least one instruction,
wherein the at least one entity is configured, by executing the at least one instruction, to:
receive, from a sensing client, a sensing request including sensing rule information to be applied to a target sensing area;
determine a sensing entity to perform a sensing operation corresponding to the sensing request based on the information element corresponding to the sensing rule information using at least one network function; and
request a sensing operation of the sensing entity,
wherein the sensing rule information includes sensing rule information specialized for the target sensing area.

12. The communication network system according to claim 11, wherein the sensing rule information includes identification information of the target sensing area and identification information of a sensing profile specialized for the target sensing area.

13. The communication network system according to claim 11, wherein the sensing rule information includes a designated sensing time, sensing measurement time intervals, a sensing resolution, a preferred sensing access technique, or a preferred sensing mode.

14. The communication network system according to claim 11, wherein the sensing rule information includes a target sensing object, sensing objectives, a set of sensing events, a list of candidate user equipments (UEs) for sensing, a group identifier (ID), or an application ID.

15. The communication network system according to claim 11, wherein the at least one entity is further configured to: acquire information on an Access and Mobility Management (AM) network function related to the sensing entity based on the information element to determine the sensing entity.

16. The communication network system according to claim 15, wherein the at least one entity is further configured to: select the sensing entity from a list of candidate UEs located within the target sensing area to determine the sensing entity.

17. The communication network system according to claim 11, wherein for requesting of the sensing operation, the at least one entity is further configured to:
transmit, to the sensing entity, information of the target sensing area; and
transmit, to the sensing entity, sensing interval, resolution, or reporting period as configuration detail information for the sensing request.

18. A method of managing a user equipment (UE) for sensing on a target sensing area, comprising:
storing and managing, by a core network, the information element corresponding to sensing rule information to be applied to a target sensing area, which is included in a sensing request received from a sensing client, in a Unified Data Repository (UDR) using at least one network function;
determining, by the core network, a UE as a sensing entity candidate for the sensing request based on a sensing entity registration request received from the UE using the at least one second network function; and
transmitting, by the core network, a sensing request message requesting a sensing operation for the sensing request to the user equipment (UE).

19. The method according to claim 18, wherein the sensing rule information includes identification information of the target sensing area and identification information of a sensing profile specialized for the target sensing area, and further includes a designated sensing time, sensing measurement time intervals, a sensing resolution, a preferred sensing access technique, a preferred sensing mode, a target sensing object, sensing objectives, or a set of sensing events.

20. The method according to claim 18, wherein the sensing entity registration request includes information on a change in an Access and Mobility Management (AMF) network function of the UE due to a change in mobility of the UE.
